(19) United States
(12) Patent Application Publication
(10) Pub. No.: US 2025/0206393 A1
(43) Pub. Date: Jun. 26, 2025

(54) OMNIDIRECTIONAL CLIMBING VEHICLE WITH MAGNETIC ADHESION FOR ACCESS TO COMPLEX METAL SURFACES

(71) Applicants: PETRÓLEO BRASILEIRO S.A. – PETROBRAS, Rio de Janeiro (BR); SERVIÇO NACIONAL DE APRENDIZAGEM INDUSTRIAL - SENAI/SC, Florianópolis (BR)

(72) Inventors: Clayton Eduardo RODRIGUES, São José dos Campos (BR); Marco Shawn MEIRELES MACHADO, Joinville (BR); Felipe FARIA, Joinville (BR); Doglas NEGRI, Joinville (BR); Saulo MELOTTI, Joinville (BR); Paulo Henrique GIUSTI, São José dos Campos (BR); Luís GONZAGA TRABASSO, Joinville (BR); Diego DE SOUZA, Joinville (BR); Walter KAPP, Joinville (BR); Ismael SECCO, Joinville (BR); Andre KOEBSCH, Rio de Janeiro (BR)

(21) Appl. No.: 18/985,545

(22) Filed: Dec. 18, 2024

(30) Foreign Application Priority Data
Dec. 22, 2023 (BR) 1020230272231

(51) Int. Cl. B62D 57/024; B60B 19/00; B60R 16/023; B60R 16/03; B60R 16/08; B62D 21/11

(52) U.S. Cl. CPC B62D 57/024; B60B 19/003; B60B 19/006; B60R 16/0231; B60R 16/03; B60R 16/08; B62D 21/11

(57) ABSTRACT

The present disclosure discloses embodiments of an omnidirectional climbing vehicle with magnetic adhesion for access on complex metal surfaces, which includes an omnidirectional wheels assembly, which includes active omnidirectional wheels and passive omnidirectional wheels, at least one power train and two magnetic units for respective pairs of omnidirectional wheels assembly of omnidirectional wheels, a suspension assembly, comprising four transverse suspensions for respective pairs of omnidirectional wheels assembly of omnidirectional wheels and a longitudinal suspension, a chassis split into a front chassis and a rear chassis, in which the longitudinal suspension interconnects the front (61) and rear (62) chassis on the Y axis, and an electrical panel (7), mounted on the front chassis.

### FIELD OF THE DISCLOSURE

The present disclosure relates to the technical field of robotic systems for operating on metal surfaces with accessibility complexity. More specifically, this disclosure relates to embodiments of an omnidirectional climbing vehicle with magnetic adhesion for access to complex metal surfaces.

### BACKGROUND OF THE DISCLOSURE

In the oil and gas industry, scanning large surfaces for repair and/or maintenance requires a large, automated positioning infrastructure, which is typically fixed in the factory. However, in the case of ship hulls and oil offshore oil platforms, this type of infrastructure is so large that it becomes economically unviable.

For a maintenance process to be applicable to large surfaces outside the horizontal plane, it is necessary to use machines and positioning systems capable of placing the process tools at any point on the surface. In conventional industrial environments, scaffolding, overhead cranes, linear guides, and anthropomorphic robots, among others, are used for this type of activity. However, there are some surfaces found in environments that do not favor the use of these more common equipments, such as offshore platforms and oil extraction vessels, in which the maintenance of metal surfaces is vital to prevent the deterioration of plant infrastructure due to oxidation and other erosive agents.

First, the offshore environments have very large surfaces, which often makes it impossible to use fixed-base equipment that can automate or mechanize a maintenance process. Another point that greatly influences the complexity of applying a maintenance process in this type of environment is the difficulty of peripheral access to the surface to be worked on. In other words, maintenance operations on the sides of ships and platforms are normally carried out from the deck or the structure itself; unlike, for example, the application of coating to a part inside a factory on dry land.

As platforms and vessels remain in operation on the high seas for a long period of time, it is not feasible to wait for docking or a complete maintenance shutdown to carry out work on the structure. In view of that, maintenance-related activities in these environments are currently carried out during full operation of the Plant and manually by workers, who are supported by ropes and cables to the side or area to be repaired. This work routine, in a way, meets the maintenance demands of the facilities, but it becomes very costly for the company, as the manual process is quite slow and dangerous, which limits the worker's productivity. And since the process is slow, the time a worker spends performing this activity on the platform is usually extended, which poses a problem for offshore plants. This is due to the strict control and rigid restrictions on worker access and stay in such locations, causing a process operator to occupy, for an excessive amount of time, a “space” on the platform that could otherwise be allocated to an operator with a different specialty.

Considering these arguments, it becomes extremely important to search for technologies that can accelerate the process of maintaining metal surfaces in offshore environments, in which many of the areas are difficult, and sometimes impossible, for humans to access without putting the worker's integrity at risk. In this context, a solution was sought that would allow the automation, flexibility and improvement of different processes required for the maintenance of such surfaces, considering the way it is currently done.

Currently, one way in which maintenance processes on oil extraction platforms and similar structures are carried out involves the use of workers specialized in industrial climbing. These professionals are suspended by ropes so that they can access the areas and surfaces where maintenance needs to be carried out, using hand tools to perform the task.

As an example of such maintenance processes, it is mentioned the application of coating in offshore environments. Specifically, industrial climbers use hand-held paint guns, powered by paint pumps mounted on the deck of the vessel/platform, applying paint “by eye” and with little control over the speed of the paint fan sweep and the distance from the gun to the surface to be coated. Furthermore, this working model does not allow the application of coating in all necessary areas, as many points of the structure are inaccessible to climbers, given the curvature or inclination of the surface, which prevents the worker from descending, also considering the safety implications of a worker attempting to access such locations.

Given these particularities, the current process is inefficient and very costly, as it requires climbers to remain on the platform for a very long time, and they can achieve an average production of 70 square meters per hour (m²/h)—logically, this productivity value is only valid for areas where climbers have safe and free access. Additionally, physical and climatic conditions can also be situational impediments to the operation of this professional, which makes the schedule of the maintenance process of a platform/vessel unpredictable and variable, thus not being advantageous for the maintenance of the plant since it is common for the work campaigns of the entire structure to take several months.

To overcome these limitations, something movable is normally used on the surface to be worked on. Several technologies can be employed, such as the use of robotic vehicles with wheels or magnetic belts, magnetic foot or suction cup feet systems, track installation, among other technical solutions.

### PRIOR ART

In the State of the Art, there is the disclosure of some documents that contain teachings regarding robotic vehicles with wheels or magnetic belts, magnetic foot systems or suction cup feet, or track installation.

Document BR 102022000551-6 discloses a robot for applying coating to hard-to-reach areas of offshore platforms and ships, such as curved, vertical surfaces, or surfaces with negative inclination angles. The robot comprises a lightweight painting system, integrated into a vehicle with magnetic shoes, which produces a constant magnetic force on the metal surface, capable of ensuring the vehicle's support in the different application areas. A floating magnetic system aims to ensure that the wheels have the necessary friction for the vehicle to move.

However, document BR 102022000551-6 presents a complex chassis structure, consisting of a suspended chassis and an articulated central axis. Furthermore, it includes a mechanical limitation related to the demands of movements under metal surfaces that simultaneously consider the attack in any direction (frontal, lateral or mixed), complex surfaces (concave, convex and twisted), any angles of inclination, and overcoming physical obstacles. Furthermore, document BR1020220005516 provides a platform that only enables the coating process.

Document U.S. Pat. No. 11,577,794 discloses a robotic device that performs an action on a curved ferromagnetic surface. The robotic device includes a chassis platform and at least one magnetic lateral drive module. The chassis platform rolls over the curved ferromagnetic surface and is held on it due to the curved surface being ferromagnetic. At least one magnetic lateral drive module is pivotally attached to the chassis platform and serves to drive the action on the curved ferromagnetic surface as the chassis platform rolls on the curved ferromagnetic surface.

However, document U.S. Pat. No. 11,577,794 teaches that only the central wheel can be replaced with an omnidirectional wheel or a magnetic omnidirectional wheel. Furthermore, it is observed that the chassis platform of the robotic device is rigid, and the flexibility is concentrated only in the possible articulation in the arm of each wheel.

Document CN111391598 discloses a robot suspension structure suitable for crawling on curved surfaces, which comprises a frame assembly, a magnetic absorption assembly, a motor, and mecanum wheels. The frame assembly comprises a longitudinal suspension assembly and a transverse curved surface adjustment suspension assembly.

However, document CN111391598 requires that a transverse adjustment knob be turned to actuate a transverse curved surface adjustment pin, thereby changing the angle of the wheels, and allowing the mecanum wheel be rigidly fixed to the curved surface.

Document WO2023184801 discloses a wall-climbing cleaning robot, comprising a frame, a first driving mechanism, a second driving mechanism, a first magnetic adsorption mechanism, and a cleaning mechanism. The first magnetic adsorption mechanism (3) is located between the first driving wheel and the second driving wheel, and the cleaning robot can perform a transition between a plurality of wall surfaces of a ship.

However, document WO2023184801 teaches a cleaning robot that, although it can perform a transition between a plurality of wall surfaces of a ship, requires these surfaces to be relatively flat, since it would obviously have difficulty in accessing surfaces with complex curvatures.

Therefore, it is clear that deficiencies persist in the State of the Art. Thus, the characteristics and advantages of the present disclosure will clearly emerge from the detailed description below and with reference to the attached drawings, these being provided only as preferred and non-limiting embodiments.

### BRIEF DESCRIPTION OF THE DISCLOSURE

The present disclosure discloses embodiments of an omnidirectional climbing vehicle with magnetic adhesion for access on complex metal surfaces, which comprises a omnidirectional wheels assembly, which includes active omnidirectional wheels (1) and passive omnidirectional wheels (5), at least one power train (2) and two magnetic units (3) for respective pairs of omnidirectional wheels assembly of omnidirectional wheels, a suspension assembly (4), comprising four transverse suspensions (41) for respective pairs of omnidirectional wheels of the omnidirectional wheels assembly and a longitudinal suspension (42), a chassis (6) split into a front chassis (61) and a rear chassis (62), in which the longitudinal suspension (42) interconnects the front chassis (61) and rear chassis (62) on the Y axis, and an electrical panel (7), mounted on the front chassis (61).

### BRIEF DESCRIPTION OF THE DRAWINGS

In order to complement the present description and to obtain a better understanding of the characteristics of the present disclosure, figures are presented in which its preferred embodiments are represented in an exemplary and non-limiting manner.

FIG. 1 illustrates a front view of the vehicle, according to an embodiment of the disclosure.

FIG. 2 illustrates a rear view of the vehicle, according to an embodiment of the disclosure.

FIG. 3 illustrates a top view of the vehicle, according to an embodiment of the disclosure.

FIG. 4 illustrates a bottom view of the vehicle, according to an embodiment of the disclosure.

FIG. 5 illustrates a left side view of the vehicle, according to an embodiment of the disclosure.

FIG. 6 illustrates an isometric view of the vehicle, according to an embodiment of the disclosure.

FIG. 7 illustrates the longitudinal attack minimum concave radius, according to an embodiment of the disclosure.

FIG. 8 illustrates the longitudinal attack minimum convex radius, according to an embodiment of the disclosure.

FIG. 9 illustrates the transverse attack minimum concave radius, according to an embodiment of the disclosure.

FIG. 10 is the transverse attack minimum convex radius, according to an embodiment of the disclosure.

FIG. 11 illustrates the essential components of the vehicle, according to an embodiment of the disclosure.

FIG. 12 illustrates the power train components, according to an embodiment of the disclosure.

FIG. 13 illustrates the electromagnetic brakes of the fail-safe system, according to an embodiment of the disclosure.

FIG. 14 illustrates the end axis components, according to an embodiment of the disclosure.

FIG. 15 illustrates the components of the central axis, according to an embodiment of the disclosure.

FIG. 16 illustrates the components of the magnetic unit, according to an embodiment of the disclosure.

FIG. 17 illustrates the vehicle suspension assembly.

FIG. 18 illustrates the transverse suspension components, according to an embodiment of the disclosure.

FIG. 19 illustrates the two-part composition of the chassis, according to an embodiment of the disclosure.

FIG. 20 illustrates the positioning barycenter for any process tools, according to an embodiment of the disclosure.

FIG. 21 illustrates limitations of longitudinal suspension, according to an embodiment of the disclosure.

FIG. 22 illustrates physical limitations of transverse suspension, according to an embodiment of the disclosure.

### DETAILED DESCRIPTION OF THE DISCLOSURE

The present disclosure relates to embodiments of an omnidirectional climbing vehicle with magnetic adhesion for access to complex metal surfaces called “difficult to access areas” of offshore platforms and ships. The aforementioned vehicle enables a robotic system to access metal surfaces that have complex curvatures, such as concave, convex surfaces with various inclination angles, including vertical or negative angles, and various physical obstacles, such as weld beads and steps between plates, allowing a wide surface scanning field with a lightweight modular infrastructure.

In order to meet this objective, the omnidirectional climbing vehicle is disclosed, with floating magnetic adhesion and passive surface adaptation means, ensuring constant adhesion force on the metal surface and, consequently, the support of the vehicle in the different application areas, as well as providing the friction necessary to promote continuous displacement and obstacle crossing.

Furthermore, the disclosure seeks to solve or reduce the limitations found in the State of the Art in robotic systems for operation on metal surfaces with complex access, especially those aimed at treatment, coating, and inspection processes in oil extraction offshore plants. In this sense, the present disclosure sought to improve upon the art in at least the following development pillars:
Adhesion: the equipment must be able to adhere to the ferromagnetic metal surfaces of the target structures;
Movement: the equipment must be able to move with the maximum possible degrees of freedom on the surface to which it is attached;
Accessibility: the equipment must, through its grip capabilities, allow movement and adaptation to the surface, being able to reach hard-to-reach places that cannot normally be accessed by industrial climbers;
Adaptability: the equipment must be able to adapt or mechanically overcome, in terms of positioning and movement, the geometric variations of the application surface, such as concave and convex curvature radii, any slopes, plate steps, and weld beads, among others.

The climbing vehicle of the present disclosure is a robotic climbing vehicle that has the ability to access difficult-to-access areas, places that the industrial climber is currently unable to reach, either due to physical impediment or safety standards. Furthermore, it is capable of accessing difficult-to-reach areas that other state-of-the-art robotic vehicles cannot access.

The omnidirectional movement and suspension concept of the vehicle of this disclosure allows rapid repositioning and movement on the work surface, thus increasing the speed in performing tasks in relation to the execution speed of an industrial climber.

The ability to teleoperate the vehicle ensures that the operator is not subjected to the hazardous environment to which the industrial climber is normally exposed, allowing processes to be carried out over longer shifts, as the operator will work in a more ergonomic and less aggressive position.

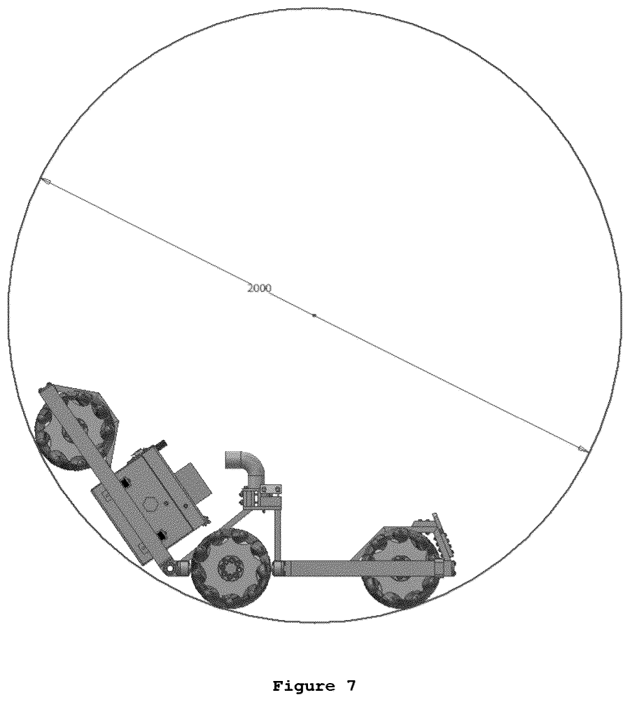

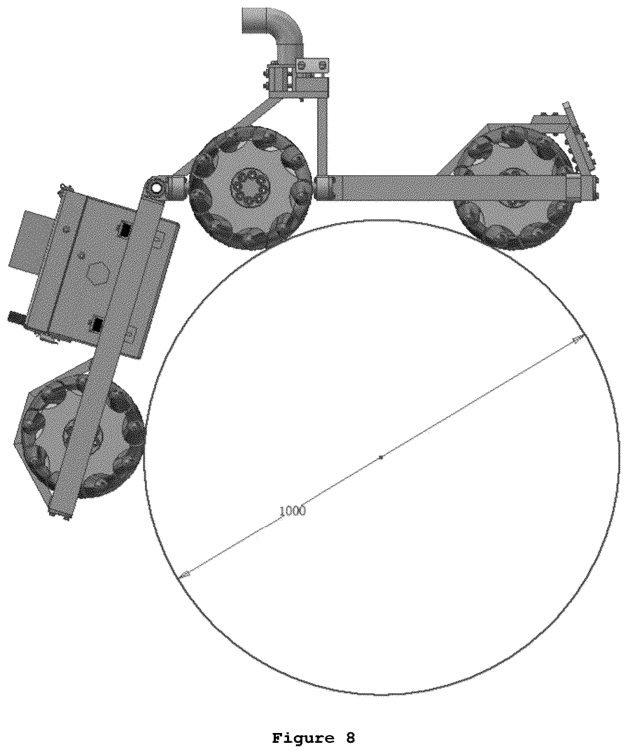

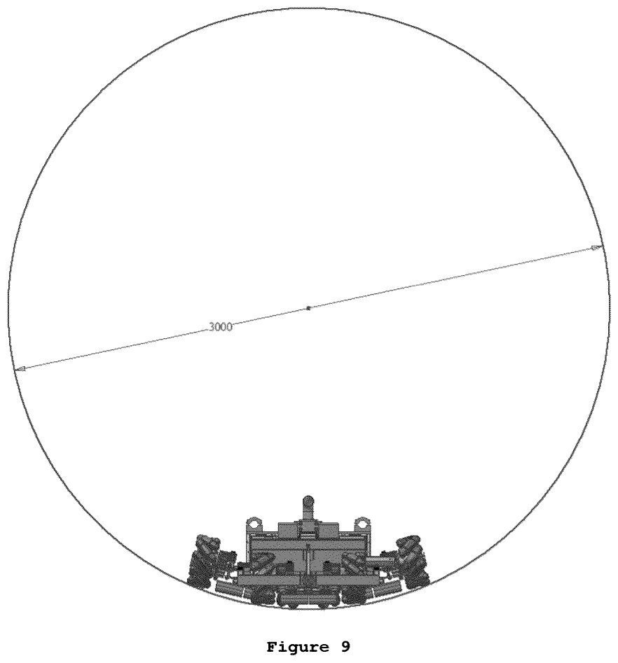

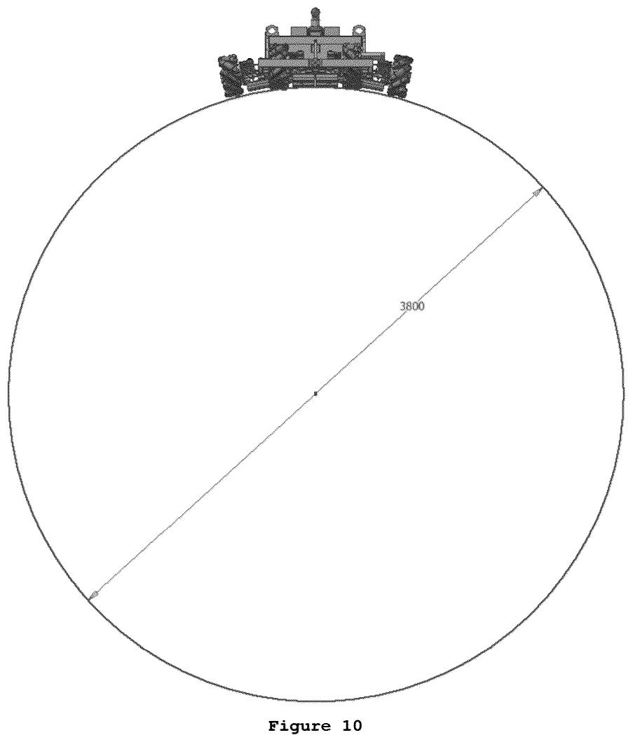

The robotic climbing vehicle is capable of adhering to and moving on surfaces made of ferromagnetic metal plates with at least 9 millimeters thick, at inclinations from 0 to 180 degrees in relation to a horizontal reference. Said vehicle has a suspension design that incorporates a passive surface adaptation mechanism, capable of allowing the vehicle to adapt to at least the following conditions: longitudinally, concave surfaces with a radius of 1000 millimeters, as illustrated in FIG. 7, and convex surfaces with a radius of 500 millimeters, as illustrated FIG. 8; transversely, concave surfaces with a radius of 1500 millimeters, as illustrated in FIG. 9, and convex surfaces with a radius of 1900 millimeters, as illustrated in FIG. 10.

Additionally, the vehicle is capable of overcoming rectangular obstacles up to 25.4 millimeters high in frontal attacks, in which case the obstacle line is perpendicular to the vehicle's X axis, as illustrated in FIG. 6, and rectangular obstacles up to 6.35 millimeters high in lateral attacks, in which case the obstacle line is perpendicular to the vehicle's Y axis. Furthermore, the vehicle is capable of operating up to 40 meters away from the central controller, where the vehicle's umbilical cord is connected to the controllers and electrical panels.

It will also be appreciated that the disclosure provides a mobile platform, allowing the implementation of process modules in its structure, thus enabling the transfer of technology to other applications, while naturally respecting the restrictions imposed previously.

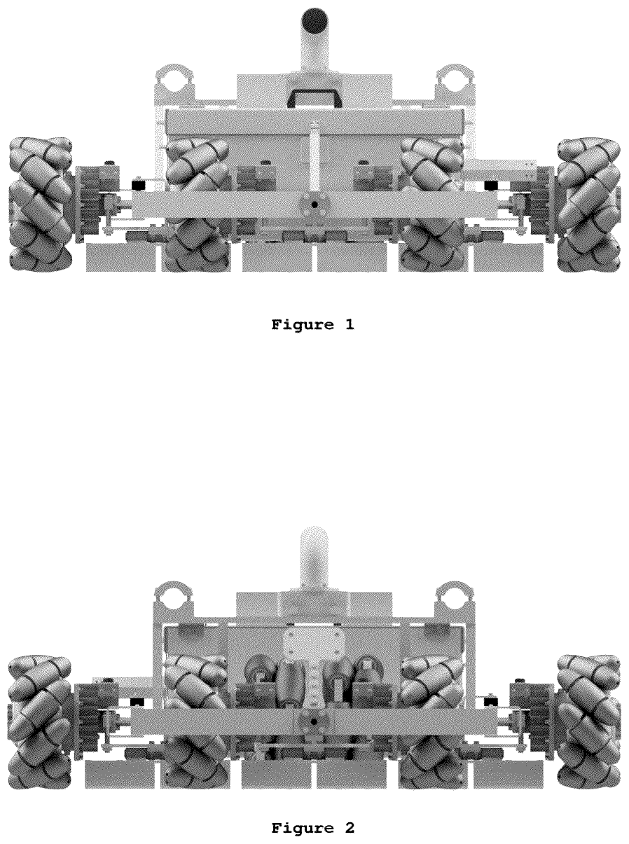

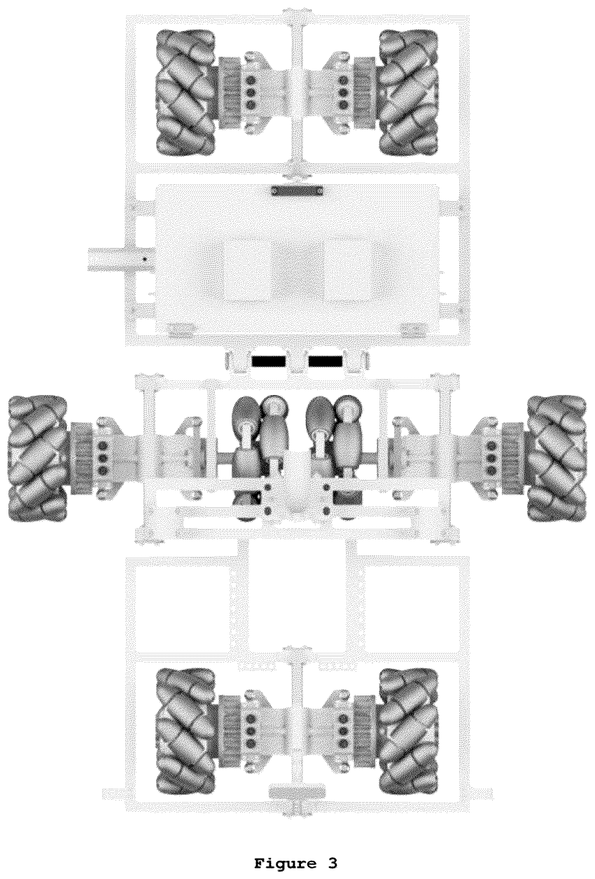

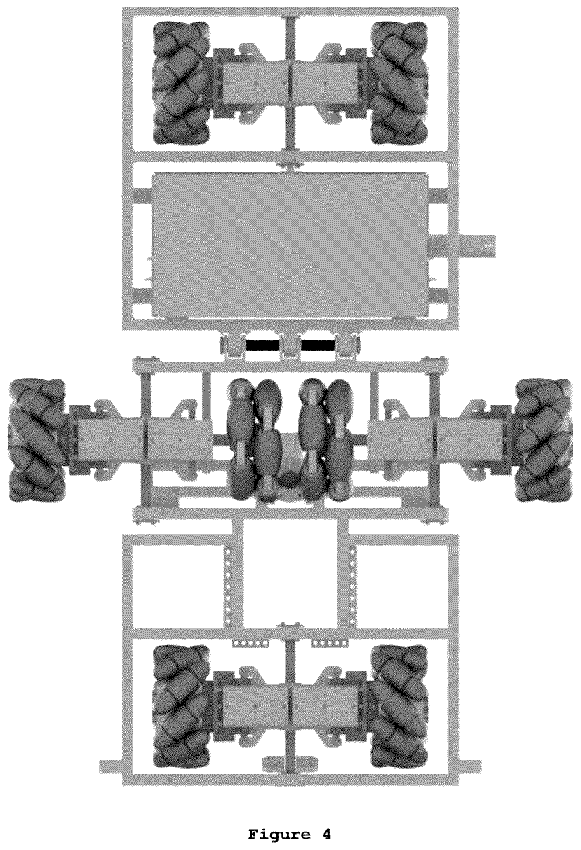

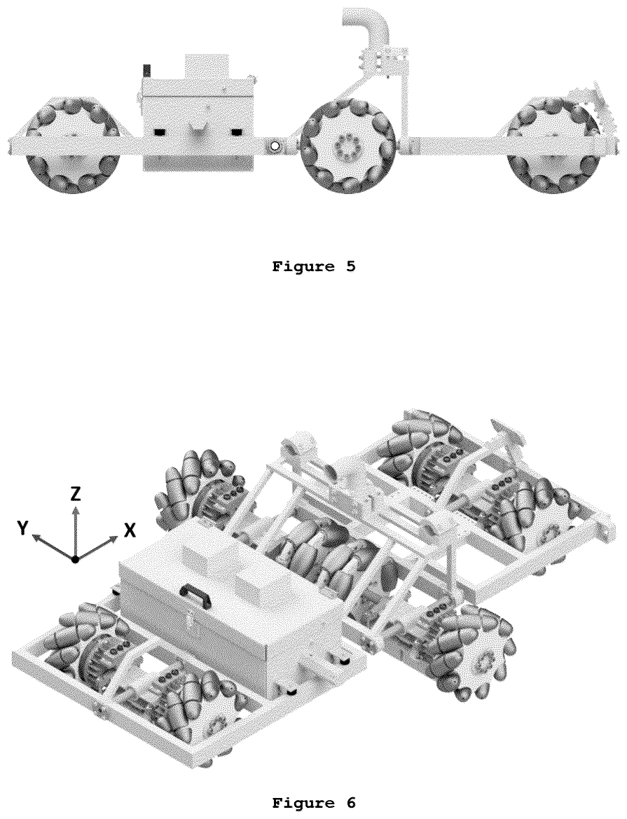

The omnidirectional climbing vehicle with magnetic adhesion for access to complex metal surfaces, according to a preferred embodiment of the present disclosure, is illustrated in FIGS. 1 to 6.

Furthermore, as illustrated in FIGS. 11 to 14, the robotic climbing vehicle comprises at least the following essential components:
Active omnidirectional wheels (1). These wheels are preferably of the type mecanum. Each active omnidirectional wheel (1) is an actuated mechanical assembly that, through the friction force generated in the tribological pair formed by the rubber of its rollers and a metal surface, is capable of transform the rotating mechanical power of a power train into omnidirectional movement of the vehicle. The assembly has a system of free rollers mounted at 45 degrees in relation to the wheel axis, allowing the vehicle to make translational movements in X and Y and rotation in Z in the normal plane of contact between the wheel and the surface. The rollers have a three-part part construction concept—a central roller and two lateral rollers, with the lateral rollers allowing obstacles to be overcome using a lateral attack.
Power train (2). The power train (2) consists of a set of controlled electromechanical actuators, which transfer power (torque and rotation) to the active omnidirectional wheels (1), allowing the vehicle to move on the surface.
Magnetic units (3). The magnetic units (3) consist of a set comprising permanent magnets and a magnetic path that concentrates the magnetic flux between the magnets and the metal surface, generating a vehicle-surface attraction force that guarantees the minimum adhesion necessary for the vehicle to be supported and moved on the surface.
Suspension (4) of the climbing vehicle. The suspension (4) is a passive mechanism that ensures geometric adaptation of the vehicle to the surface profile; that is, it ensures that the wheels (1) and magnetic units (3) remain orthogonal to the surface regardless of irregularities and obstacles, ensuring the maintenance of the acting adhesion force.
Passive omnidirectional wheels (5). These wheels are preferably of the type mecanum. Each passive omnidirectional wheel (5) is a passive mechanical assembly that completes the functionality of the suspension (4), responsible for protecting the working volume of the magnetic unit (3). The set has a free roller system mounted at 90 degrees in relation to the wheel axis and does not influence the vehicle's movements. With ten conventional rollers, it also guarantees the overcoming of obstacles in frontal and lateral attacks.
Chassis (6). The chassis (6) is a rigid structure preferably made of structural aluminum tubes and machined connection components, which primary functions are to ensure the mechanical interconnection between the other vehicle subassemblies, provide sufficient rigidity for securing process tools, and withstand the dynamic loads generated by the adhesion and surface adaptation systems. The chassis is split, with the front chassis responsible for attaching an electrical panel and the rear chassis for attaching process tools and other secondary components.
Electrical panel (7). The electrical panel (7) is a closed power distribution and electrical control panel for the vehicle, in which the electrical power, energy conversion, communication, sensing, control and heat dissipation equipment are mounted.

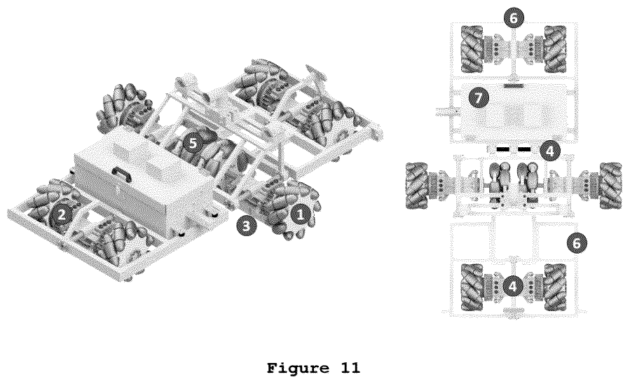

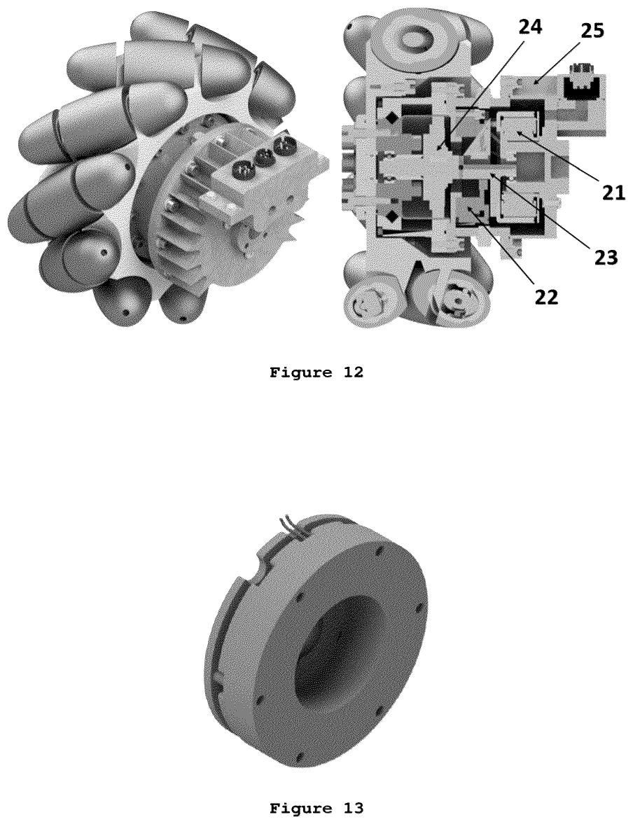

The vehicle is preferably equipped with six active omnidirectional wheels (1) and six power trains (2). As illustrated in FIG. 12, each power train (2) consists of an electric motor (21), an electromagnetic brake (22) configured for fail-safe actuation, a speed reducer (23), and a transmission axis (24)—all enclosed by a split casing (25) and immersed in transmission oil for lubrication and cooling of the system. These mechanical components are responsible for generating, amplifying and transferring torque to the hub of the active omnidirectional wheel (1). Thanks to the compactness of the designed system, the assembly of most of the power train components (2) occupies the internal volume of the wheel itself (1).

As illustrated in FIG. 13, the electromagnetic brake (22) is responsible for the fail-safe system. It is a commercially available component, but with the replacement/adaptation of the original brake lining for a brake lining designed to operate immersed in oil. It will be appreciated by a person skilled in the art that, so that braking time is not affected by oil immersion (dynamic friction), the new lining facilitates the flow of oil across the surface in the radial direction, increasing the availability of surface area for the action of quasi-static friction in braking conditions. The critical braking torque sum occurs when the vehicle is moving in the direction of the gravity vector, but in the opposite direction and 45 degrees away from the X axis, since in this case the movement (and consequently, the braking) are generated by only three active wheels (1)—the other active wheels (1) are at zero rotation (only the rollers (11) in contact with the surface).

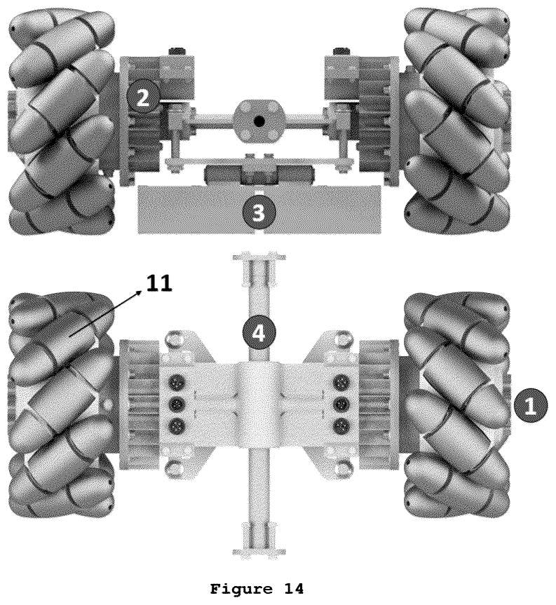

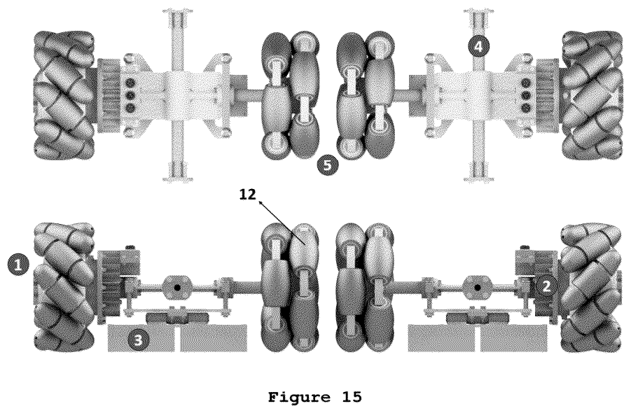

FIG. 14 shows the details of the active omnidirectional wheel assembly (1), power trains (2), centralized magnetic unit (3), and suspension (4) belonging to the end axis, while FIG. 15 presents the respective central axis assembly with the addition of the passive omnidirectional wheels (5).

The vehicle has two end axis and a central axis, totaling three axis-one for redundancy to prevent the vehicle from becoming inoperative if one of them fails, with each axis having two power trains (2) and, consequently, two active wheels (1) on each side. Thus, based on the kinematics developed and implemented, the resulting spatial configuration of the active (1) and passive (5) wheels allows the vehicle to be able to move in any direction, including rotating around its center of gravity. The active wheels (1) are equipped with nine rollers (11) equally spaced on the radial contour of preferably 130 millimeters, designed in a tripartite manner and with a given curvature at both ends, so as to provide the lateral attack angle necessary to ensure that the vehicle is able to overcome certain obstacles, such as weld beads and steps between plates, when moving in the transverse direction.

Passive wheels have 10 rollers each and do not influence the vehicle's active kinematics—their function is to keep not only the magnetic unit within the wheels' radius of action, but also to maintain the ability to overcome lateral obstacles and the functioning of the surface adaptation mechanism. The rollers (11 and 12) on both wheels are vulcanized with a specific rubber with a high coefficient of friction, to ensure that the vehicle has the mechanical adhesion necessary to move on ferromagnetic surfaces arranged in any direction (vertical, on complex curves, different degrees of negative inclination, or even in the inverted horizontal position—“overhead”).

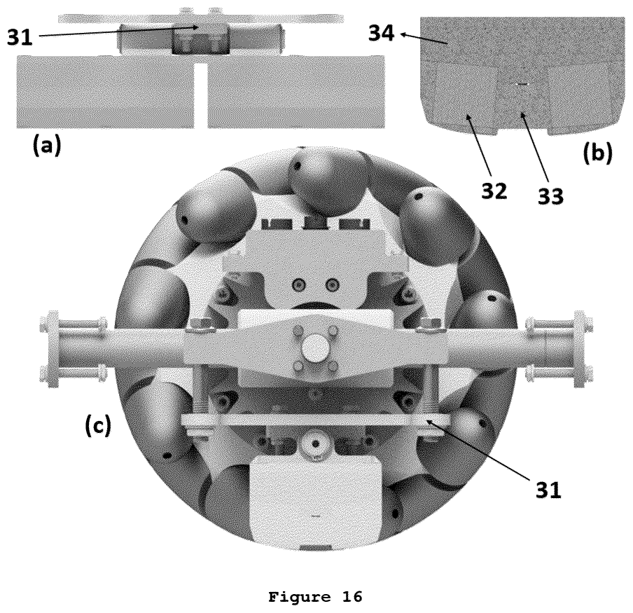

It will be appreciated that since mechanical adhesion depends not only on the coefficient of friction of the rollers (11) but also on the magnitude of the normal force relative to the ferromagnetic surface, each pair of wheels (1 and 5) has two magnetic units (3) attached to a passive mechanical force maintenance assembly (31) that allows the degrees of freedom (DOF) of translation on the Z axis and rotation on the Y axis, as illustrated in FIG. 16a—these DOF are important as they allow the magnetic unit to remain orthogonal to the surface by maintaining the magnetic path and passively adapting when the magnetic unit collides physical obstacle on the surface.

As illustrated in FIG. 16b, the magnetic units (3) consist of permanent magnets (32) enclosed by a sleeve of non-magnetic material (33), which in turn is fixed to a ferromagnetic core (34) that provides optimized induction of the magnetic field between the magnetic unit (3) and the ferromagnetic substrate, which consequently generates the normal magnetic force necessary to ensure adhesion of the vehicle to the surface. The geometric design of the magnetic unit (3) prioritizes not only the optimization of the magnetic flux density (normalized relationship between the magnetic force and the weight force), but also its actuation inserted in the radius of the wheels (1 and 5) so that the surface adaptation mechanism works correctly, as illustrated in greater detail in FIG. 16c.

The suspension (4) is formed by two types of independent suspensions, as illustrated in FIGS. 17a-c. The suspension (4) is comprising four transverse suspensions (41) that connect the four pairs of wheels to the front (61) and rear (62) frames by rigid revolution joints (411) on the X axis and a longitudinal suspension (42) that interconnects the front (61) and rear (62) frames by self-lubricating bushings (421) on the Y axis.

The transverse suspension (41), illustrated in greater detail in FIG. 17b, has the primary function of ensuring the passive mechanism of adaptation to the surface of the axis in the transverse direction, keeping the magnetic unit (3) orthogonal to the surface and, consequently, the minimum magnetic adhesion force required for the vehicle when it operates on complex surfaces.

On the other hand, the longitudinal suspension (42), illustrated in greater detail in FIG. 17c, is responsible for enabling the passive mechanism of adaptation to the vehicle surface in the longitudinal direction, mainly during the vehicle's launch and return times, when it frontally engages the gunwale radius.

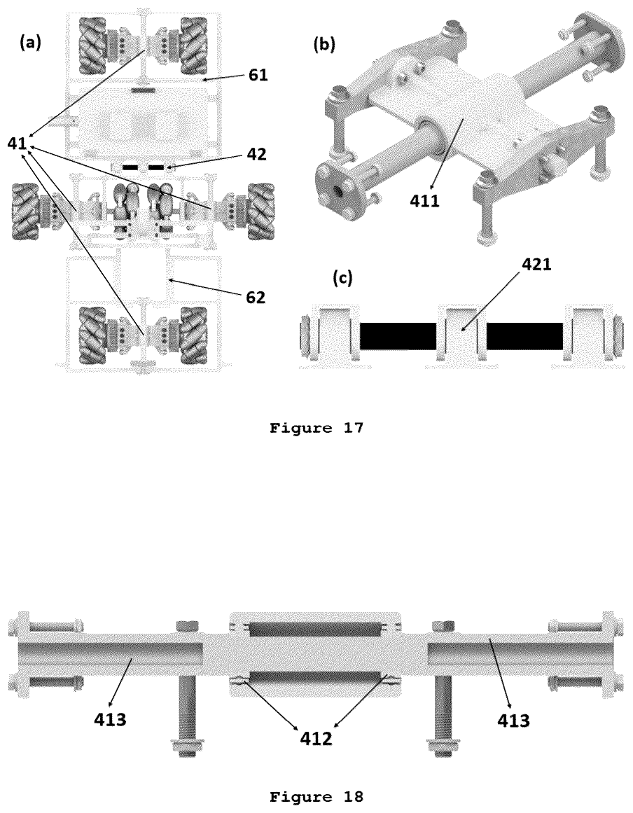

As can be seen in FIG. 18, the transverse suspension has a double bearing assembly (412) with angular contact ball bearings, back-to-back assembly to resist radial and axial loads (both directions), and stainless steel axis (413), so that the mechanical assembly of the wheel pairs (1 and 5) resists dynamic stresses and has, mainly, translational rigidity on the X axis and rotational rigidity on the Z axis sufficient to avoid translations and unwanted rotations, according to the activation of the vehicle's active wheels (1).

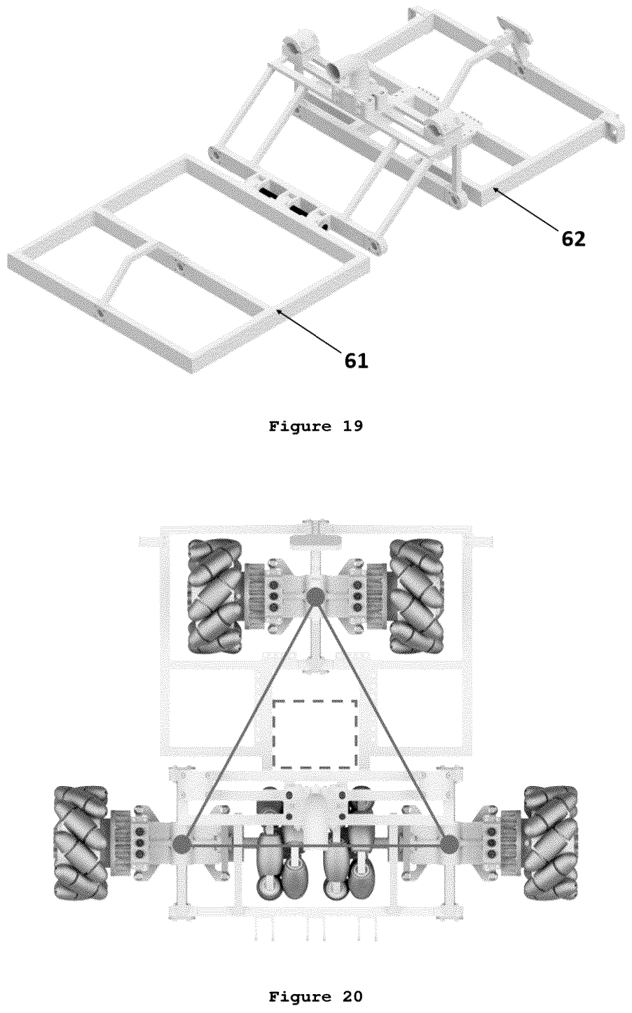

As illustrated in FIG. 19, the chassis (6) is the primary structural element of the vehicle and has a two-part construction concept. The front (61) and rear chassis (62) are interconnected by the longitudinal suspension (42). Both are welded and comprise aircraft-grade aluminum structural tubes and machined connection components. The front frame (61) has only two power trains—one end axis—and is responsible for attaching the electrical panel (7), while the rear chassis (62) has 4 drive trains-one end axis and the central axis—and provides sufficient rigidity and working volume for coupling any and all process tools to be used. Additionally, the rear chassis (62) provides locations for attaching secondary mechanical components such as umbilical crimps, pneumatic manifold, and hose positioners.

With regard to the kinematics of the longitudinal suspension (42), it will be appreciated that the front chassis (61) has a point of contact with the surface (pair of active wheels) and the DOF of rotation in relation to the line of revolution (Y axis) fixed on the rear chassis (62)—this being a rigid structure with three points of contact (one pair of active wheels and two pairs of active/passive wheels) with the surface and, consequently, zero DOF.

The primary function of the chassis (6) is to withstand the loads imposed during service and to ensure the rigidity and dynamic stability necessary for the tools to perform operations effectively, in accordance with previously parameterized physical variables, ensuring the final quality of maintenance and/or repair activities.

The electrical panel (7) is preferably mounted on the top of the front chassis (61), on the opposite side in which the process tools are mounted, in order to balance the vehicle's center of gravity. An umbilical bundle containing power electrical and pneumatic connections and communication reaches the interior of the electrical panel (7) via connectors. A static DC-DC converter lowers the input supply voltage, internally distributing the DC voltages that power other electrical devices, such as controllers, drivers, communication interfaces, and relays, among others. Next, there are cable glands, through which the engine control cables (21) are distributed throughout the vehicle and fixed in layout prescribed in the chassis (6) and suspension (4) of the vehicle.

The umbilical bundle contains electrical power and communication for the vehicle's electrical panel (7), in addition to the power and control cables for the process tools and the compressed air supply for actuating the pneumatic systems. The umbilical has its entry point at a mechanical terminal on the upper part of the rear chassis (62) and, from this location, the various cables of the bundle are distributed through the chassis (6) and suspension (4) to their appropriate terminals for use.

As illustrated in FIG. 20, the rear chassis (62) provides a sufficient working volume for fixing any process tools close to its geometric barycenter, formed by the triangle of three existing support points—three pairs of wheels, two on the central axis and one adjacent to the end axis.

It will be appreciated that omnidirectional movement on any surface requires three DOFs of movement, namely: two orthogonal translations and one orientation with the rotation axis normal to the surface. The active omnidirectional wheels (1) allow this type of movement from the control of two axis, each with a pair of active wheels with opposing roller propellers (11)—left and right. This makes a total of four wheels needed for three DOFs of movement. However, this minimum condition only works well when the traction capacity is balanced between each of the wheels, which is only possible on nearly flat horizontal surfaces—for other surface conditions, the suspension mechanism (4) must be activated to adapt to the surface.

In the case of the application of the robotic climbing vehicle of disclosure, this the surfaces will have any orientation in relation to the gravity vector, but will mostly be vertical surfaces which, for the mechanical adhesion requirement, represent the critical case, since the support of the vehicle on the surface depends entirely on the friction forces acting between the active wheels (1) and the surface. In this specific case, as the center of mass (CM) of the vehicle with its payload will never be on the surface, but rather away from it, the moment generated by the weight force with the CM lever arm in relation to the surface unbalances the normal force of the active wheels (1) against the surface (generated by the magnetic adhesion system (3)), reducing this contact force and, consequently, the traction of the wheels superior in relation to the gravity vector. For this reason, the robotic climbing vehicle adds the redundancy of three axis with pairs of active wheels (1) and opposing propellers. Thus, when the longitudinal direction of the vehicle (X axis) is aligned with the gravity vector, the central axis maintains an average load, the lower axis has its load increased, and the upper axis has its load reduced, but there will always be two axis with two pairs of wheels with full traction capacity. On the other hand, in the case where the transverse axis (Y) of the vehicle is aligned with the gravity vector, the entire moment of the weight force is applied to the central axis, with an active wheel (1) above with an increase in its traction capacity and the opposite pair reduced. However, in this condition, the two end axis are pivoted and do not receive this moment, therefore being responsible for maintaining control of the vehicle.

The robotic climbing vehicle of the present disclosure also has a suspension mechanism (4) with an independent linear kinematic solution, capable of passively adapting to any surface and distributing the dynamic demands arising from the interaction between active wheels (1) and surface. The vehicle has six active and two passive contact points, which must adapt to any surface in a rigid and independent manner, and the adhesion force must be fully maintained. To this end, the vehicle is equipped with four transverse suspensions (41), one longitudinal suspension (42) and four force maintenance systems (31)—together, these assemblies make the vehicle capable of adapting to any surface irregularities without compromising adhesion, as the eight contact points can independently articulate in a rigid manner and simultaneously the working spacing (gap) of the magnetic units (3) is kept constant during the articulation process.

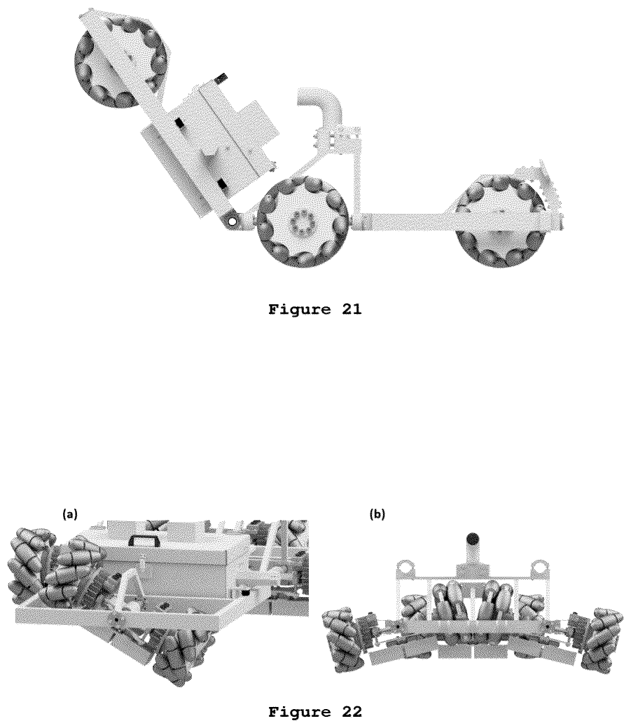

The longitudinal suspension (42) provides the necessary rotational GOF for adaptation to concave or convex surfaces in frontal attack and to twisted surfaces during omnidirectional movements of the vehicle. The only limitation of the longitudinal suspension (42) is physical and occurs in adaptations in which an angle in the second quadrant is required, as illustrated in FIG. 21, due to the imminent collision between the electrical panel (7) and the umbilical press located on the rear chassis (62)—the maximum angle is preferably 55 degrees. In other situations, there are no limitations, since the longitudinal suspension (42) adapts the vehicle to the surface and the mechanical force maintenance system (31) works simultaneously to keep the magnetic units (3) orthogonal to the surface, through the action of the rotation DOF induced by the magnetic flow.

Unlike the transverse suspension (41), the longitudinal suspension comprises three ball joints, due to the polymeric nature of the self-lubricating bushings, adopted to reduce the vehicle's mass. Although it does not reduce the amount of DOF of the joint (three rotations), such an amount of ball joints is used so that the transverse suspension (41) is rigid enough to work adequately in adapting to complex surfaces and capable of absorbing impacts arising from overcoming obstacles on the front chassis (61).

The transverse suspension (41) provides the necessary rotational DOF for adaptation to concave or convex surfaces in lateral attack and also to twisted surfaces during omnidirectional movements of the vehicle. There are two physical limitations of the transverse suspension (41): the first occurs on the end axis, as illustrated in FIG. 22a, with a maximum angle of 30 degrees in both directions due to the imminent collision between the power train (2) and the front chassis (61); the second is recurrent on the central axis, with a maximum angle of 14 degrees in both directions to avoid collisions of the passive omnidirectional wheels (5) with the rear chassis (62) and between them, as illustrated in FIG. 22b. In other situations there are no limitations, since the transverse suspension (41) adapts the vehicle's wheel pairs to the surface and the mechanical force maintenance system (31) works simultaneously to maintain the magnetic units (3) in working spacing, through the action of the translation DOF induced by the magnetic flow (this DOF is also important when overcoming obstacles).

Composing any overlapping surfaces (concave, convex or twisted) and physical obstacles (welding beads, steps between plates, etc.) in any direction of attack—due to the omnidirectionality of the vehicle, there will always be a kinematic solution in which the surface adaptation mechanism will be compatible, thanks to the new vehicle concept comprising passive longitudinal (42) and transverse (41) suspensions, pairs of wheels with central magnetic units (3) and a passive mechanical system for force maintenance (31).

The transverse suspension (41) is subjected to critical radial loads when a pair of active wheels (1) acts with torques in opposite directions to add to the friction forces and generate linear forward movement on the Y axis, while critical axial loads are generated when a pair of active wheels (1) acts with torques in the same direction for linear forward movements on the X axis.

The double bearing arrangement (412) with angular contact ball bearings is responsible for resisting these dynamic stresses, including the bearings being arranged in a back-to-back configuration due to the possibility of changing the direction of axial forces and dimensioned for the lower end axis to the vehicle's center of mass, as it is the axis that receives the moment generated by the mass of the assembly.

In other dynamic conditions, not mentioned above, the axial force generated by the active wheels (1) is canceled within the end and central axis assemblies themselves, since the active wheels (1) associated with a given axis always have the roller helices (11) opposite (left and right).

However, it will be appreciated by a person skilled in the art that it is advisable to avoid excessive displacements and rotations in the transverse suspension pivot (41), so that the active wheels (1) maintain spatial alignment and the vehicle kinematics are not affected. For this, the three translational and rotational rigidities of the pivot are ensured not only by the rigidity of the assembly resulting from the active wheels (1) and magnetic units (3), as well as the neutral line designed in stainless steel added to the resulting triangular structure in the chassis (6).

A critical condition for longitudinal suspension (42) occurs when the vehicle moves laterally and needs to overcome obstacles and/or irregularities on the surface, generating radial and axial loads of similar magnitudes, mainly due to the transposition performed by the pairs of wheels on the central axis. The trio of self-lubricating bushings of the revolution joint supports the surface pressure exerted by the radial load, while the axial force is fully absorbed by the neutral axis made up of an anodized aluminum tube.

The moments around the Z axis generated both on the end axis and on the central axis, under conditions when the active wheel pairs (1) work with resultant friction forces in opposite directions on the X axis (couple moment), are transferred to the chassis (6) through the stainless steel neutral line at two opposite and coplanar points. The transfer and resistance to the resulting bending force is bipartite, thus avoiding the emergence of stress concentrations in the front (61) and rear (62) chassis that compromise their mechanical resistance.

It will be appreciated that the mechanical design prioritizes the positioning and attachment of all adjacent subassemblies and components to the front (61) and rear chassis (62) so that the resulting center of mass is as close as possible to the plane passing through the neutral lines of the active wheels (1), aiming to reduce the moment generated and, consequently, the imbalance of adhesion loads on the vehicle's axis. Furthermore, the spatial configuration of the subassemblies and, mainly, of the umbilical crimpers and process hoses is approximately symmetrical in the X-Y plane, so that the payloads do not negatively influence the vehicle kinematics due to the eccentricity between the center of mass and the geometric center of the developed kinematics.

It will be appreciated that the vehicle has a payload (applied to the rear chassis (62)) in the range of 40 to 45 kg for any process tools and in the range of 70 to 80 kg for the umbilical bundle.

Those skilled in the art will value the knowledge presented herein and will be able to reproduce the disclosure in the presented embodiments and in other variants, covered in the scope of the appended claims.

1. An omnidirectional climbing vehicle with magnetic adhesion for access to complex metal surfaces, the vehicle comprising:
an omnidirectional wheel assembly, which includes active omnidirectional wheels and passive omnidirectional wheels;
at least one power train, two magnetic units and a passive mechanical assembly of force maintenance for respective pairs of omnidirectional wheels of the omnidirectional wheel assembly;
a suspension assembly, consisting of four transverse suspensions (41) for respective omnidirectional wheel pairs of the omnidirectional wheel assembly and a longitudinal suspension (42);
a chassis (6) split into a front chassis and a rear chassis, in which the longitudinal suspension interconnects the front and rear chassis on the Y axis; and
an electrical panel, mounted on the front chassis.

2. The omnidirectional climbing vehicle according to claim 1, wherein the vehicle comprises six active omnidirectional wheels and six power trains, wherein each power train comprises an electric motor, electromagnetic brake, speed reducer, and transmission axis, all enclosed by a bipartite housing and immersed in transmission oil.

3. The omnidirectional climbing vehicle according to claim 1, wherein the vehicle comprises two end axis and a central axis with redundancy.

4. The omnidirectional climbing vehicle according to claim 1, wherein the vehicle comprises each pair of wheels has two magnetic units attached to a mechanical assembly.

5. The omnidirectional climbing vehicle according to claim 1, wherein the vehicle comprises the longitudinal suspension connects the front and rear chassis by self-lubricating bushings.

6. The omnidirectional climbing vehicle according to claim 1, wherein the transverse suspension has a double bearing assembly (412) with angular contact ball bearings mounted back-to-back and a stainless steel axis.

7. The omnidirectional climbing vehicle according to claim 1, wherein the front chassis aggregates two power trains on one end axis.

8. The omnidirectional climbing vehicle according to claim 1, wherein the rear chassis has four drive trains, two on an end axis and two on a central axis, where the central axis comprises two passive omnidirectional wheels.

9. The omnidirectional climbing vehicle according to claim 1, wherein the rear chassis also has a working volume for fixing process tools.

10. The omnidirectional climbing vehicle according to claim 1, wherein the rear chassis provides locations for attaching secondary mechanics components, such as umbilical crimpers, pneumatic manifold, and hose positioners.

11. The omnidirectional climbing vehicle according to claim 1, wherein the electrical panel is mounted on the top of the front chassis, on an opposite side to which process tools are mounted on the rear chassis.

12. The omnidirectional climbing vehicle according to claim 1, further comprising an umbilical bundle containing electrical power and communication for the vehicle's electrical panel, power and control cables for the process tools, and a compressed air supply for actuating the pneumatic.

13. The omnidirectional climbing vehicle according to claim 1, wherein the vehicle comprises the umbilical has its entry point at a mechanical terminal on the upper part of the rear chassis.

14. The omnidirectional climbing vehicle according to claim 1, wherein the at least two magnetic units (3) are fixed to an assembly.

15. The omnidirectional climbing vehicle according to claim 1, wherein the suspension assembly (and the chassis provide the degrees of freedom necessary for adaptation to complex surfaces in frontal, lateral or mixed attack conditions.

16. The omnidirectional climbing vehicle according to claim 1, wherein the omnidirectional wheel assembly comprising an active wheel and a passive wheel, and wherein the transverse suspension provides a safe enclosure to prevent the two magnetic units from colliding with any physical obstacles on the ferromagnetic surface.

17. The omnidirectional climbing vehicle according to claim 1, wherein the transverse suspension and the passive mechanical force maintenance assembly are responsible for the degrees of freedom necessary to maintain the working gap and orthogonal positioning to the surface of the magnetic units, thus ensuring constant action of the magnetic adhesion forces during movements on complex surfaces and/or overcoming obstacles under any vehicle attack conditions.
